(19) United States
(12) Patent Application Publication
(10) Pub. No.: US 2025/0271980 A1
(43) Pub. Date: Aug. 28, 2025

(54) INTERFACE SWITCHING METHOD AND APPARATUS, AND INTERACTION METHOD FOR TERMINAL DEVICE

(71) Applicant: Beijing Zitiao Network Technology Co., Ltd., Beijing (CN)

(72) Inventors: Daoyu WANG, Beijing (CN); Xingyou LI, Beijing (CN); Xingyi WANG, Beijing (CN)

(21) Appl. No.: 18/858,259

(22) PCT Filed: Apr. 18, 2023
(86) PCT No.: PCT/CN2023/089052

§ 371 Date: Oct. 18, 2024

(30) Foreign Application Priority Data
Apr. 20, 2022 (CN) 202210418796.7

(51) Int. Cl. G06F 3/0484

(52) U.S. Cl. CPC G06F 3/0484

(57) ABSTRACT

Provided are an interface switching method and apparatus, an interaction method for a terminal device, an electronic device, a computer-readable storage medium. Provided is an interface switching method. The method includes: in response to an interface switching instruction triggered by a user, determining a target visual element from a first interface or a second interface, wherein the interface switching instruction is used for instructing to switch the first interface to the second interface, and the target visual element is a visual element shared by the first interface and the second interface; adding a target visual element to a top view layer of a first position of a first interface, the first position being an original position of the target visual element in the first interface. In this manner, during interface switching, common visual elements are first topped and then displaced, thereby ensuring displacement continuity of the visual elements.

### CROSS REFERENCE

This application claims priority to Chinese Patent Application No. 202210418796.7, filed with the Chinese Patent Office on Apr. 20, 2022 and entitled ‘INTERFACE SWITCHING METHOD AND APPARATUS, AND INTERACTION METHOD FOR TERMINAL DEVICE’, which is incorporated herein by reference in its entirety.

### FIELD

The present disclosure relates to the field of information interaction technologies, and in particular, to an interface switching method and apparatus, an interaction method for terminal device, an electronic device, a computer readable storage medium, a computer program product, and a computer program.

### BACKGROUND

With the development of network technologies, various types of video applications are increasingly deeply introduced into people's lives. When a user uses a video application, mutual switching between interfaces of different types may be performed based on different viewing requirements.

In the related art, the switching of the interfaces can be accomplished by overlaying the switched interfaces on the interfaces before the switching. However, coherent displacement of visual elements cannot be visually presented only through interface switching done by mutual coverage between interfaces, thereby degrading the user experience.

### SUMMARY

The present disclosure provides an interface switching method and apparatus, an interaction method for a terminal device, an electronic device, a computer-readable storage medium, a computer program product and a computer program.

According to a first aspect, an embodiment of the present disclosure provides an interface switching method, including:
in response to an interface switching instruction triggered by a user, extracting a target visual element from a first interface or a second interface, the interface switching instruction being used for instructing to switch the first interface to the second interface, the target visual element being a visual element shared by the first interface and the second interface;
adding the target visual element to a top layer of a view of a first position of the first interface, the first position being an original position of the target visual element in the first interface;
in response to switching the first interface to the second interface, moving the target visual element from the first position to a second position of the target visual element in the second interface.

According to a second aspect, an embodiment of the present disclosure provides an interface switching apparatus, including:
an extraction module, configured to in response to an interface switching instruction triggered by a user, extract a target visual element from a first interface or a second interface, the interface switching instruction being used for instructing to switch the first interface to the second interface, the target visual element being a visual element shared by the first interface and the second interface;
an adding module, configured to add the target visual element to a top layer of a view of a first position of the first interface, the first position being an original position of the target visual element in the first interface;
a switching module, configured to, in response to switching the first interface to the second interface, move the target visual element from the first position to a second position of the target visual element in the second interface.

According to a third aspect, an embodiment of the present disclosure provides an interaction method for terminal device, the method comprising:
displaying a first interface;
in response to a triggering operation of a user on the first interface, controlling the first interface to perform a first deformation, and triggering an interface switching instruction;
in response to detecting that the triggering operation ends, performing the described interface switching method;
displaying a target visual element in a second interface;
wherein, during a process of switching the first interface to a second interface, the target visual element after the first deformation performs a second deformation.

According to a fourth aspect, an embodiment of the present disclosure provides an electronic device, including:
a processor; and
a memory for storing a computer program;
wherein, the processor is configured to implement, by executing the computer program, the interface switching method described in the foregoing first aspect and various possible designs of the first aspect.

According to a fifth aspect, an embodiment of the present disclosure provides a computer readable storage medium. The computer readable storage medium stores a computer executable instruction. When a processor executes the computer executable instruction, the interface switching method in various possible designs of the first aspect and the first aspect is implemented.

According to a sixth aspect, an embodiment of the present disclosure provides a computer program product, including a computer program. When being executed by a processor, the computer program implements the interface switching method described in the foregoing first aspect and various possible designs of the first aspect.

According to a seventh aspect, an embodiment of the present disclosure provides a computer program. When being executed by a processor, the computer program implements the interface switching method in the foregoing first aspect and various possible designs of the first aspect.

Embodiments of the present disclosure provide an interface switching method and apparatus, an interaction method for terminal device, an electronic device, a computer readable storage medium, a computer program product, and a computer program, in response to an interface switching instruction triggered by a user, extracting a target visual element from the first interface or the second interface. The interface switching instruction is used for instructing to switch the first interface to the second interface, and the target visual element is a visual element shared by the first interface and the second interface. Subsequently, the target visual element is added to the top layer of the view at a first position of the first interface, the first position being the original position of the target visual element in the first interface. Finally, when the first interface is switched to the second interface, the target visual element is moved from the first position to the second position of the target visual element in the second interface.

### BRIEF DESCRIPTION OF THE DRAWINGS

To describe the technical solutions in the embodiments of the present disclosure or the related technologies more clearly, the following briefly introduces the accompanying drawings required for describing the embodiments or the related technologies, Apparently, the accompanying drawings in the following description show some embodiments of the present disclosure, and other drawings may also be obtained according to these drawings without creative efforts.

FIG. 1 is a schematic flowchart of an interface switching method according to an embodiment of the present disclosure.

FIG. 2 is a schematic diagram of interface switching according to an embodiment of the present disclosure.

FIG. 3 is a schematic flowchart of an interaction method for a terminal device according to an embodiment of the present disclosure.

FIG. 4 is a schematic diagram of a triggering operation according to an embodiment of the present disclosure.

FIG. 5 is a schematic flowchart of another interface switching method according to an embodiment of the present disclosure.

FIG. 6 is a flowchart of yet another interface switching method according to an embodiment of the present disclosure.

FIG. 7 is a schematic diagram of a structure of an interface switching apparatus according to an embodiment of the present disclosure.

FIG. 8 is a schematic diagram of a structure of an electronic device according to an embodiment of the present disclosure.

### DETAILED DESCRIPTION

Embodiments of the present disclosure will be described in more detail below with reference to the accompanying drawings. Although certain embodiments of the present disclosure are shown in the drawings, it should be understood that the present disclosure may be implemented in various forms and should not be construed as being limited to the embodiments set forth herein, but rather these embodiments are provided for a thorough and complete understanding of the present disclosure. It should be understood that the drawings and embodiments of the present disclosure are only for illustrative purposes and are not intended to limit the scope of the present disclosure.

It should be understood that the steps recorded in the method embodiments of the present disclosure may be executed in different orders, and/or executed in parallel. Furthermore, method embodiments may include additional steps and/or omit the performing of illustrated steps. The scope of the present disclosure is not limited in this respect.

The term “comprising” and variations thereof, as used herein, is open end inclusive, i.e., “including but not limited to.” The term “based on” is “based at least in part on”. The term “one embodiment” means “at least one embodiment”; the term “another embodiment” means “at least one further embodiment”; The term ‘some embodiments’ means ‘at least some embodiments’. Relevant definitions of other terms will be given in the following description.

It should be noted that the modifications of ‘a’ and ‘a plurality’ mentioned in the present disclosure are illustrative rather than restrictive, and those skilled in the art should understand that they should be understood as ‘one or more’ unless the context clearly indicates otherwise.

In the related art, the switching of the interfaces can be accomplished by overlaying the switched interfaces on the interfaces before the switching. However, coherent displacement of visual elements cannot be visually presented only through interface switching done by mutual coverage between interfaces, thereby degrading the user experience.

In addition, it is also possible to disguise the displacement of a visual element by using a false element generated through taking a screenshot of the visual element, and by shifting the false element. However, coherent play of the internal animation of the visual element during the interface switching cannot be achieved through the disguise of the fake element.

With regard to the described technical problem, the present disclosure aims to extract a common target visual element from a first interface before switching or a second interface after switching, and place the target visual element at the top layer of a view of the first interface, and then displace the target visual element during interface switching. By means of the method, not only the visual displacement continuity of a target visual element can be ensured, but also the playing continuity of an internal animation of the target visual element during an interface switching process can be ensured, thereby improving the user experience.

The application scenario of the interface switching method provided by the present disclosure will be described below.

In an interface switching method, the interface switching method provided in this embodiment may be applied to a scenario of a video application. When a user uses a video application, switching between different playing interfaces may be performed, for example, a full-screen playing interface may be switched to an image-text playing interface. The full-screen playing interface contains an image carousel component, and the image-text playing interface contains an image carousel component and a text display component. After receiving a switching instruction triggered by a user, a common image carousel component may be extracted from a full-screen playing interface or an image-text playing interface, and is placed at the top layer of a view of an interface before switching. Subsequently, during the switching between the full-screen playing interface and the image-text playing interface, the image carousel component may be displaced from a position in the interface before the switching to a position in the interface after the switching.

In another method for switching interfaces, the method for switching interfaces provided in this embodiment may be applied to a scenario of an instant messaging application. When a user uses an instant messaging application, if a video is being played in a conversation, the user can switch between a full-screen playing interface and a window playing interface. In the switching process, the video carousel component may also be extracted from the full-screen playing interface or the window playing interface, and is placed at the top layer of the view of the interface before switching. Subsequently, during the switching process of the full-screen playing interface and the window playing interface, the video carousel component can be displaced from the position in the interface before switching to the position in the interface after switching.

It should be noted that the foregoing two application scenarios do not limit the present disclosure, and the interface switching method provided in the present disclosure may be applied to any interface switching scenario.

It may be understood that the foregoing method for switching interfaces may be implemented by using the interface switching apparatus provided in the embodiments of the present disclosure. The interface switching apparatus may be a part or all of a certain device, for example, a terminal device or a processor of the terminal device.

The technical solutions of the embodiments of the present disclosure will be described in detail below with reference to specific embodiments. The following specific embodiments may be combined with each other, and the same or similar concepts or processes may not be repeated in some embodiments.

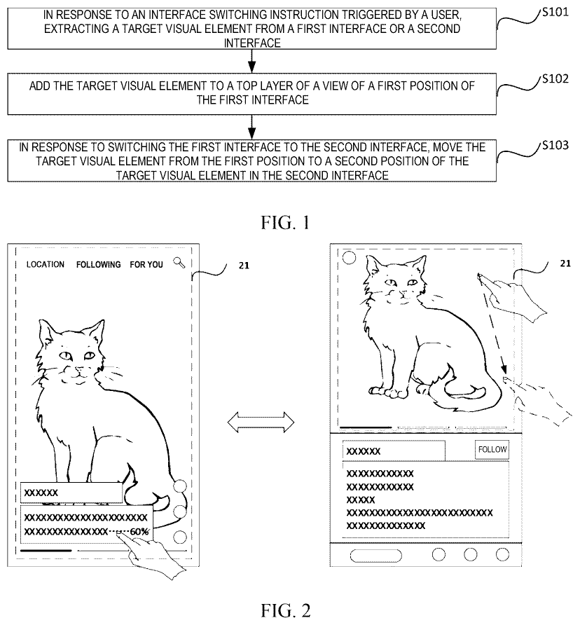

FIG. 1 is a schematic flowchart of an interface switching method according to an embodiment of the present disclosure. As shown in FIG. 1, the interface switching method provided in this embodiment includes:

step 101, in response to an interface switching instruction triggered by a user, extracting a target visual element from a first interface or a second interface.

Wherein, the interface switching instruction is used for instructing to switch the first interface to the second interface.

It should be understood that the first interface and the second interface may be any interface in an application. In some embodiments, switching may be performed back and forth between the first interface and the second interface through a switching instruction triggered by a user.

Exemplarily, if the application is a video playing application, the first interface may be a full-screen playing interface, and the second interface may be an image-text playing interface. The user may trigger the interface switching instruction to switch the full-screen playing interface to the image-text playing interface, and may also trigger the interface switching instruction to switch the image-text playing interface to the full-screen playing interface.

It should be understood that the visual element disclosed in the present disclosure may be a component displayed in the first interface or the second interface. Accordingly, the target visual element may be a visual element shared by the first interface and the second interface. Exemplarily, the target visual element may include an image carousel component, a video carousel component, a text carousel component, and the like.

In some embodiments, the target visual element disclosed in the present disclosure may include at least one piece of content to be played, and each piece of content to be played may be connected through a preset animation effect.

Wherein the content to be played may be determined according to the type of the target visual element, and if the target visual element is an image carousel component, accordingly, the content to be played is an image; if the target visual element is a video carousel component, correspondingly, the content to be played is a video; and if the target visual element is a text carousel component, correspondingly, the content to be played is a text.

It should be noted that, in the embodiments of the present disclosure, there is no limitation on how the user triggers the interface switching instruction, and in some embodiments, the user may trigger the interface switching instruction by performing a triggering operation on the display interface of the terminal device.

Exemplarily, the triggering operation may include a tap, a slide at a preset angle, and the like. Exemplarily, the slide at the preset angle may, for example, be a slide downward between 75° and 115° with respect to a horizontal plane.

The triggering operation such as clicking or sliding at a preset angle may be performed in a specific area on the display interface, or may be performed in any area on the display interface, which is not limited in the embodiment of the present disclosure.

In other embodiments, when a triggering operation of the user is detected, the display interface of the terminal device may perform a corresponding display change. Exemplarily, when a triggering operation of a user is detected, a display interface of a terminal device may be zoomed out, and when it is detected that the triggering operation of the user is completed, interface switching may be performed and the display interface of the terminal device may be zoomed in, and then a target visual element is displayed in the display interface.

Exemplarily, FIG. 2 is a schematic diagram of interface switching according to an embodiment of the present disclosure. As shown in FIG. 2, the first interface is a full-screen playing interface, and the second interface is an image-text playing interface. If the user clicks the text area floating on the image carousel component 21 in the full-screen playing interface, a first switching instruction is triggered, and the terminal device switches from the full-screen playing interface to the image-text playing interface. If the user slides downwards at the display position corresponding to the image carousel component 21 in the image-text playing interface, a second switching instruction is triggered, and the terminal device switches from the image-text playing interface to the full-screen playing interface. Wherein, the image carousel component 21 may be the target visual element described above.

It should be understood that, the embodiment of the present disclosure does not limit on how to extract the target visual element, and in some embodiments, the target visual element may be extracted from the view tree of the first interface or the second interface. The view tree contains the visual elements of each layer of the view in the interface, and is stored according to the level of layers of the view.

Exemplarily, the terminal device may compare the first interface and the second interface, so as to use a visual element shared by the first interface and the second interface as the target visual element. Subsequently, the terminal device may extract the target visual element from the first interface, and may also extract the target visual element from the second interface.

It should be noted that the target visual element extracted from the first interface and the target visual element extracted from the second interface have different animation playing parameters.

The animation playing parameter includes a view state of the target visual element and an animation effect included by the target visual element.

It should be understood that the animation effect is a switching effect between the played contents in the target visual element, and the animation effect between different played contents may be the same or different.

It should be understood that, the view state is used to indicate the playing progress of the playing content in the target visual element, which may be implemented by using the offset in the view state. In other embodiments, the view state may further include information such as a service parameter, so as to indicate information such as the size of the target visual element and the playing dubbing.

Step 102: add the target visual element to a top layer of a view of a first position of the first interface.

In this step, after the terminal device extracts the target visual element, the target visual element may be added to the top layer of the view of the first position of the first interface.

Wherein, the first position is the original position of the target visual element in the first interface.

In some embodiments, if the target visual element is a visual element extracted from the first interface, the terminal device may directly perform interface switching and move a position of the target visual element.

In other embodiments, if the target visual element is a visual element extracted from the second interface, after adding the target visual element to the top layer of the view of the first position of the first interface, the terminal device further needs to synchronize the first animation playing parameter of the target visual element in the first interface with the second animation playing parameter of the target visual element in the second interface.

Exemplarily, the terminal device may traverse and save a view state and an animation effect of the target visual element in the first interface first. Subsequently, a view state and an animation effect of the target visual element in the first interface are sequentially added to the second animation playing parameter.

In the present disclosure, by synchronizing the first animation playing parameter with the second animation playing parameter, the view state and animation effect of the target visual element extracted from the second interface are completely in consistent with those of the target visual element in the first interface, so that the user cannot perceive the switching between the target visual elements during the interface switching process. In addition, extracting the target visual element from the second interface can also avoid the problem that the target visual element is frequently moved, and guarantee the stability during the interface switching process.

In some embodiments, in response to the target visual element being added to the top layer of the view of the first position of the first interface, the target visual element may also be kept to perform the playing of an animation according to the playing progress corresponding to the view state.

The playing progress may be determined according to the playing content indicated by the offset in the view state.

At Step 103, in response to switching the first interface to the second interface, move the target visual element from the first position to a second position of the target visual element in the second interface.

In this step, after the terminal device acquires and processes the target visual element, the first interface may be switched to the second interface, and during the switching process, the target visual element is moved from the first position to the second position of the target visual element in the second interface.

It should be understood that the embodiment of the present disclosure does not limit on how to determine the second position. In some embodiments, the terminal device may first obtain the relative position between the target visual element and the reference visual element in the second interface, and then convert the relative position between the target visual element and the reference visual element in the second interface into the second position.

The reference visual element may be any visual element in the terminal device, and the second position of the target visual element may be determined according to a relative position between the target visual element and the reference visual element and a relative position between the reference visual element and the display interface.

In some embodiments, during the movement of the target visual element, a special effect may further be added to the target visual element, thereby optimizing the visual experience of the user.

It should be understood that, in the embodiment of the present disclosure, a special effect type of the target visual element added during movement is not limited, and exemplarily, the target visual element may be a gradient special effect, an afterimage special effect, or the like.

In other embodiments, after the terminal device switches the first interface to the second interface and completes the displacement of the target visual element, the target visual element may be placed back in a corresponding layer of the second interface, thereby completing the switching of the interfaces.

The obtaining method for a virtual resource provided in the embodiments of the present disclosure comprises: in response to an interface switching instruction triggered by a user, extracting a target visual element from a first interface or a second interface, the interface switching instruction being used for instructing to switch the first interface to the second interface, the target visual element being a visual element shared by the first interface and the second interface. Subsequently, the target visual element is added to the top layer of the view of a first position of the first interface, the first position being the original position of the target visual element in the first interface. Finally, in response to switching the first interface to the second interface, move the target visual element from the first position to a second position of the target visual element in the second interface. In this manner, during the interface switching, a shared visual element is first topped and then displaced, which not only ensures visual displacement continuity of a target visual element, but also ensures playing continuity of an internal animation of the target visual element during the interface switching, thereby improving user experience.

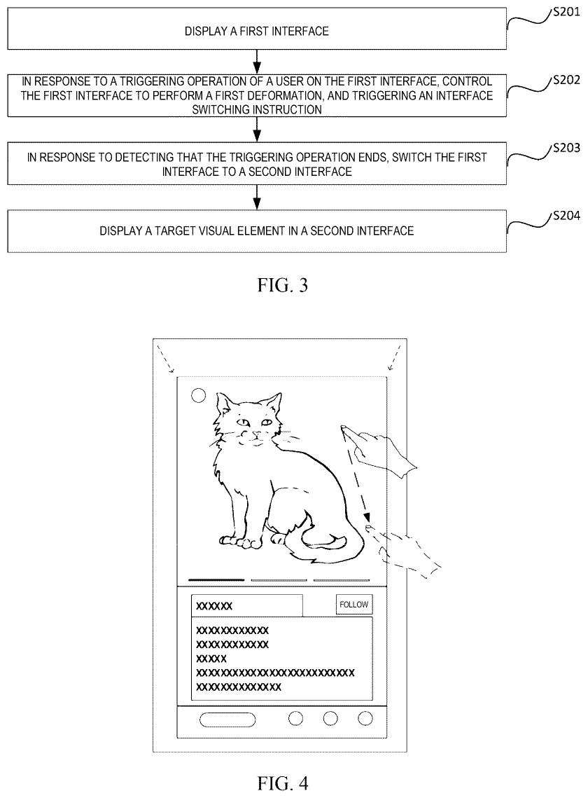

On the basis of the above embodiment, the interaction process with the user during the process of switching interfaces will be described below. FIG. 3 is a schematic flowchart of an interaction method for a terminal device according to an embodiment of the present disclosure. As shown in FIG. 3, the interaction method for a terminal device according to the embodiment includes:

In step S201, display a first interface.

In step S202, in response to a triggering operation of a user on the first interface, control the first interface to perform a first deformation, and triggering an interface switching instruction.

Exemplarily, in response to a triggering operation of the user on the first interface, the first interface is zoomed out and an interface switching instruction is triggered.

It should be understood that, in the embodiments of the present disclosure, the triggering operation is not limited, and in some embodiments, the triggering operation may include sliding at a preset angle on the screen of the terminal device according to the animation playing parameter.

As an example, the preset angle of sliding may be, for example, between 75° and 115° downward with respect to horizontal plane.

It should be understood that, in the embodiments of the present disclosure, the triggering area for the triggering operation on the screen of the terminal device is not limited, and in some embodiments, the area where the target visual element is located may be the triggering area for triggering the operation on the screen of the terminal device.

In addition, the embodiment of the present disclosure does not limit the zoom out proportion of the display interface. Exemplarily, the display interface may be reduced to 80%, 70%, or the like of the display interface before the triggering operation.

FIG. 4 is a schematic diagram of a triggering operation according to an embodiment of the present disclosure. As shown in FIG. 4, when the user needs to switch the image-text playing interface to the full-screen playing interface, if it is detected that the user slides downwards in an area of an image carousel component of the full-screen playing interface at an angle within a range of 75° to 115° with respect to a horizontal plane, an interface switching instruction may be triggered. Meanwhile, the display interface may be zoomed out as shown in FIG. 4, and is maintained in a zoom-out state when the user performs the triggering operation.

In step S203, in response to detecting that the triggering operation ends, switch the first interface to a second interface.

It should be understood that, the embodiment of the present disclosure does not limit on how to detect the end of the triggering operation. In some embodiments, when it is detected that the user ends the sliding on the terminal device, the end of the triggering operation may be determined. In other embodiments, when it is detected that the triggering part such as the user's finger leaves the screen of the terminal device, it may be determined that the triggering operation ends.

In step S204, display a target visual element in a second interface; wherein, during a process of switching the first interface to a second interface, the target visual element after the first deformation performs a second deformation.

Exemplarily, the second deformation may be a deformation operation opposite to the first deformation, for example, when the first deformation is performed on the first interface and the first interface performs a zoom out operation, then the target visual element performs the second deformation and the target visual element performs a zoom in operation. Thus, the target visual element may achieve a continuously changing state.

In the embodiments of the present disclosure, an interface switching instruction is triggered by sliding at a preset angle on a screen of a terminal device, and a display interface is zoomed in and zoomed out in a process of switching an interface. By means of the method, interactivity with a user during an interface switching process can be improved, thereby improving user experience.

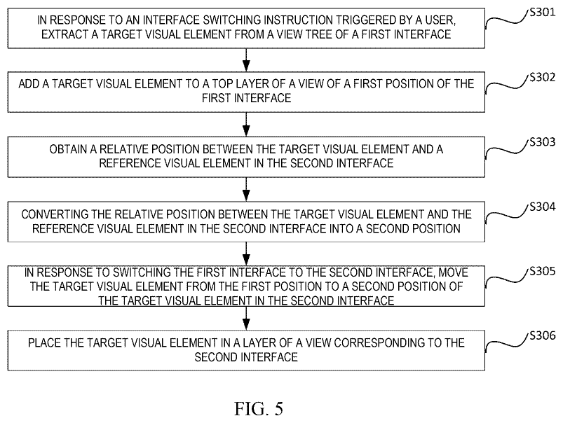

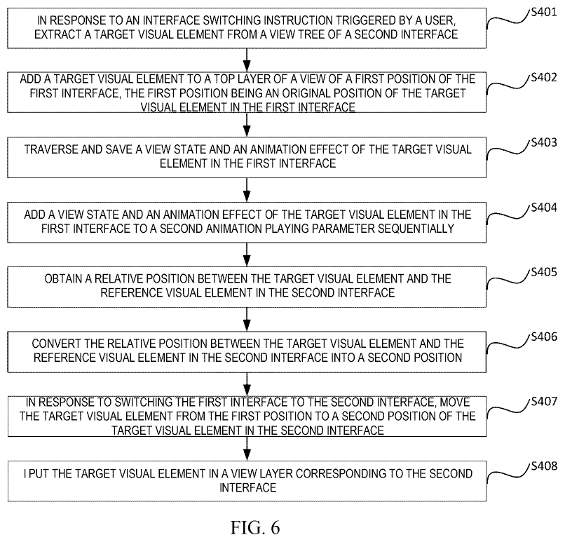

On the basis of the foregoing embodiment, the following describes two manners for extracting a target visual element. FIG. 5 is a schematic flowchart of another interface switching method according to an embodiment of the present disclosure. FIG. 5 relates to a processing flow of a target visual element extracted from a first interface. As shown in FIG. 5, the interface switching method provided in this embodiment comprises:

In step S301: in response to an interface switching instruction triggered by a user, extract a target visual element from a view tree of a first interface.

Wherein, the interface switching instruction is used for instructing to switch a first interface to a second interface, and a target visual element is a visual element shared by the first interface and the second interface.

It should be understood that the view tree contains the visual elements of each level of layer of the view in the interface, and is stored according to the level of layer of the view.

In step S302: add a target visual element to a top layer of a view of a first position of the first interface, the first position being an original position of the target visual element in the first interface.

Step S303, obtain a relative position between the target visual element and a reference visual element in the second interface.

Step S304, converting the relative position between the target visual element and the reference visual element in the second interface into a second position.

It should be understood that the embodiment of the present disclosure does not limit on how to determine the second position. In some embodiments, the terminal device may first obtain the relative position between the target visual element and the reference visual element in the second interface, and then convert the relative position between the target visual element and the reference visual element in the second interface into the second position.

Wherein, the reference visual element may be any visual element in the terminal device, and the second position of the target visual element may be determined by a relative position between the target visual element and the reference visual element and a relative position between the reference visual element and the display interface.

In step S305: in response to switching the first interface to the second interface, move the target visual element from the first position to a second position of the target visual element in the second interface.

In some embodiments, during the movement of the target visual element, a special effect may further be added to the target visual element, thereby optimizing the visual experience of the user.

In step S306, place the target visual element in a layer of a view corresponding to the second interface.

Wherein, the layer of a view corresponding to the second interface is a view layer where the target visual element was originally located in the second interface.

The technical terms, technical effects, technical features and optional implementations of steps S301-S306 can be understood with reference to S101-S103 shown in FIG. 1, and repeated contents will not be described herein.

FIG. 6 is a schematic flowchart of yet another interface switching method according to an embodiment of the present disclosure. FIG. 6 relates to a processing flow of a target visual element extracted from a second interface. As shown in FIG. 6, the interface switching method provided in this embodiment comprises:

Step S401: in response to an interface switching instruction triggered by a user, extract a target visual element from a view tree of a second interface.

Wherein, the interface switching instruction is used for instructing to switch a first interface to a second interface, and a target visual element is a visual element shared by the first interface and the second interface.

Step S402: add a target visual element to a top layer of a view of a first position of the first interface, the first position being an original position of the target visual element in the first interface.

Step S403: traverse and save a view state and an animation effect of the target visual element in the first interface.

Wherein, the view state may include an offset and a service parameter.

Step S404: add a view state and an animation effect of the target visual element in the first interface to a second animation playing parameter sequentially.

In the present disclosure, by giving the view state of the target visual element in the first interface to the second animation playing parameter, it can be guaranteed that the view state of the target visual element added at the top layer of the view is synchronous with the view state of the original target visual element in the first interface. Correspondingly, by adding the animation effect of the target visual element in the first interface to the second animation playing parameter, it can be ensured that the animation effect of the target visual element added at the top layer of the view is synchronous with the animation effect of the original target visual element in the first interface.

In step S405: obtain a relative position between the target visual element and the reference visual element in the second interface.

Step S406: convert the relative position between the target visual element and the reference visual element in the second interface into a second position.

Step S407: in response to switching the first interface to the second interface, move the target visual element from the first position to a second position of the target visual element in the second interface.

Step S408: Put the target visual element in a view layer corresponding to the second interface.

The technical terms, technical effects, technical features and optional implementations of steps S401-S408 can be understood with reference to S101-S103 shown in FIG. 1, and repeated contents will not be repeated herein.

The obtaining method for a virtual resource provided in the embodiments of the present disclosure comprises: in response to an interface switching instruction triggered by a user, extracting a target visual element from a first interface or a second interface, wherein the interface switching instruction is used for instructing to switch the first interface to the second interface, and the target visual element is a visual element shared by the first interface and the second interface. Subsequently, the target visual element is added to the top layer of the view of a first position of the first interface, the first position being the original position of the target visual element in the first interface. Finally, in response to switching the first interface to the second interface, the target visual element is moved from the first position to the second position of the target visual element in the second interface. In this manner, during the interface switching, a shared visual element is first topped and then displaced, which not only ensures visual displacement continuity of a target visual element, but also ensures playing continuity of an internal animation of the target visual element during the interface switching, thereby improving user experience.

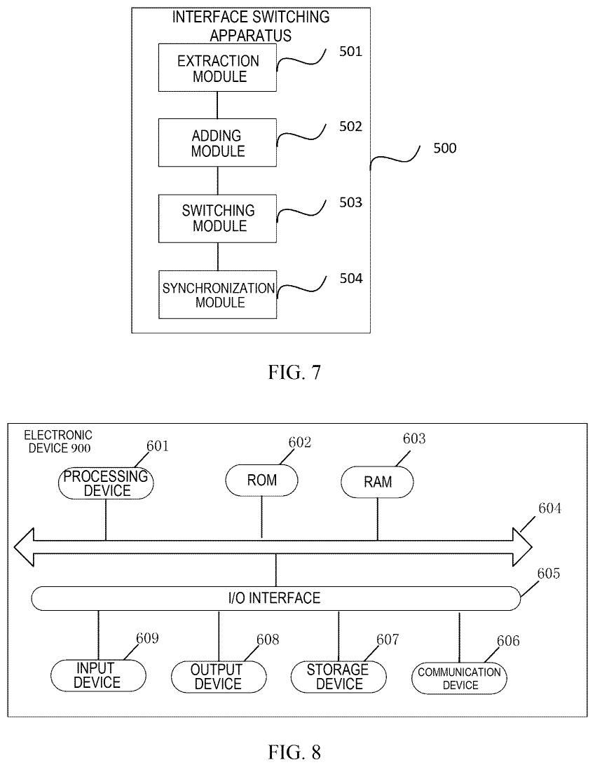

FIG. 7 is a structural schematic diagram of an interface switching apparatus according to an embodiment of the present disclosure. As shown in FIG. 7, the interface switching apparatus 500 provided in this embodiment includes: an extraction module 501, an adding module 502, a switching module 503, and a synchronization module 504.

A extraction module 501 is configured to in response to an interface switching instruction triggered by a user, extract a target visual element from a first interface or a second interface, the interface switching instruction being used for instructing to switch the first interface to the second interface, the target visual element being a visual element shared by the first interface and the second interface.

An adding module 502 is configured to add the target visual element to a top layer of a view of a first position of the first interface, the first position being an original position of the target visual element in the first interface.

A switching module 503 is configured to in response to switching the first interface to the second interface, move the target visual element from the first position to a second position of the target visual element in the second interface.

According to one or more embodiments of the present disclosure, an animation playing parameter of a target visual element extracted from the first interface is different from an animation playing parameter of a target visual element extracted from the second interface.

According to one or more embodiments of the present disclosure, the animation playing parameter comprises a view state of the target visual element and an animation effect comprised by the target visual element;

Wherein, the view state is used for indicating a playing progress of a playing content in the target visual element, the animation effect being a switching effect between playing contents in the target visual element.

According to one or more embodiments of the present disclosure, the interface switching apparatus 500 further includes:
a synchronization module 504, configured to synchronize a first animation playing parameter of the target visual element in the first interface with a second animation playing parameter of the target visual element in the second interface.

According to one or more embodiments of the present disclosure, the synchronization module 504 is specifically configured to traverse and save a view state and an animation effect of the target visual element in the first interface; sequentially adding the view state and the animation effect of the target visual element in the first interface to the second animation playing parameter.

According to one or more embodiments of the present disclosure, the switching module 503 is further configured to keep the target visual element to perform animation playing based on a playing progress corresponding to the view state.

According to one or more embodiments of the present disclosure, the first position and the second position are relative positions of the target visual element on a display interface.

According to one or more embodiments of the present disclosure, the switching module 503 is further used for obtaining a relative position between the target visual element and a reference visual element in the second interface; converting the relative position between the target visual element and the reference visual element in the second interface into the second position.

According to one or more embodiments of the present disclosure, the target visual element comprises an image carousel component, a video carousel component, or a text carousel component.

It should be noted that the interface switching apparatus provided in the embodiment shown in FIG. 7 may be configured to execute the method provided in any one of the foregoing embodiments, and specific implementation and technical effects are similar, which are not described herein again.

FIG. 8 is a schematic diagram of a structure of an electronic device according to an embodiment of the present disclosure. As shown in FIG. 8, it shows a schematic diagram of an electronic device 900 suitable for implementing the embodiment of the present disclosure. The terminal device in the embodiment of the present disclosure may include, but is not limited to, a mobile phone, a laptop, a digital broadcast receiver, a Personal Digital Assistant, (PDA), a tablet computer (Portable Android Device, PAD), a portable multimedia player (Portable Media Player, PMP), a vehicle-mounted terminal (for example, a vehicle-mounted navigation terminal), a wearable electronic device, and other mobile terminals having an image acquisition function, and a fixed terminal externally connected to an image acquisition device, such as a digital TV, a desktop computer, an intelligent home device, and the like. The electronic device shown in FIG. 8 is merely an example and should not bring any limitation to the functions and scope of use of the embodiments of the present disclosure.

As shown in FIG. 8, the electronic device 900 may include processing apparatus 601 (e.g., a central processing unit, a graphics processor, etc.) that may perform various suitable actions and processes in accordance with a program stored in a read only memory (ROM) 602 or a program loaded from a memory 607 into a random access memory (RAM) 603. A variety of programs and data necessary for the operation of the electronic device 600 are also stored in the RAM 603. The processing device 601, the ROM 602, and the RAM 603 are connected to each other via the bus 604. an input/output (Input/Output, I/O) interface 605 is also connected to the bus 604, and a memory is used for storing a program for executing the method of each of the described method embodiments. The processor is configured to execute programs stored in the memory to implement the functionality of the above-described embodiments of the present disclosure and/or other desired functionality.

In general, the following devices may be connected to the I/O interface 605: input devices 609 including, for example, touch screens, touch pads, keyboards, mice, cameras, microphones, accelerometers, gyroscopes, etc.; an output device 608 including, for example, a liquid crystal display (LCD), a speaker, a vibrator, and the like; a storage device 607 including, for example, a magnetic tape, a hard disk, and the like; and a communication device 606. Communication device 606 may allow electronic device 900 to communicate wirelessly or wired with other devices to exchange data. While FIG. 8 illustrates an electronic device 900 having various means, it is to be understood that not all of the illustrated means are required to be implemented or provided. More or fewer devices may alternatively be implemented or provided.

In particular, the processes described above with reference to the flowcharts can be implemented as computer software programs in accordance with embodiments of the present disclosure. For example, embodiments of the disclosure include a computer program product comprising a computer program carried on a non-transitory computer-readable medium, the computer program comprising program code for executing the method as shown in the flowcharts of the embodiments of the disclosure. In such embodiments, the computer program may be downloaded and installed from the network via communications device 606, or installed from storage device 607, or installed from ROM 602. When the computer program is executed by the processing device 601, the described functions defined in the method according to the embodiment of the present disclosure are executed. Embodiments of the present disclosure also include a computer program which, when executed by a processor, implements the described functions defined in the method of embodiments of the present disclosure.

It should be noted that the computer readable medium in the present disclosure may be a computer readable signal medium or a computer readable storage medium, or any combination thereof. A computer-readable storage medium may be, for example, but not limited to, an electronic, magnetic, optical, electromagnetic, infrared, or semiconductor system, apparatus, or component, or any suitable combination of the foregoing. More specific examples of the computer readable storage medium may include, but are not limited to, an electrical connection having one or more wires, a portable computer diskette, a hard disk, a random access memory (RAM), a read-only memory (ROM), an erasable programmable read-only memory (Electrical Programmable ROM, an EPROM or flash memory), an optical fiber, a portable compact disc read only memory (Compact Disc ROM, CD-ROM), an optical storage device, a magnetic storage device, or any suitable combination of the foregoing. In the present disclosure, a computer readable storage medium may be any tangible medium that can contain or store a program for use by or in connection with an instruction execution system, apparatus, or component. While in the present disclosure, a computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may also be any computer readable medium that is not a computer readable storage medium and that can communicate, propagate, or transport a program for use by or in connection with an instruction execution system, apparatus, or component. Program code embodied on a computer readable medium may be transmitted using any appropriate medium, including, but not limited to, wireline, optical fiber cable, Radio Frequency (RF), etc., or any suitable combination of the foregoing.

The computer readable medium may be included in the electronic device, or may exist separately and not be installed in the electronic device.

The computer readable medium bears one or more programs. When the one or more programs are executed by the electronic device, the electronic device is enabled to display a first photographing interface in response to a first instruction triggered by a user, wherein the first photographing interface comprises a plurality of target photographing modes; in response to a triggering operation of a user on a first photographing interface, obtaining a first virtual resource, and displaying an icon corresponding to the first virtual resource on the first photographing interface; wherein the plurality of target photographing modes include at least one variable photographing mode, and the variable photographing mode is configured to change with time.

Computer program code for carrying out operations for aspects of the present disclosure may be written in any combination of one or more programming languages, including, but not limited to, an object oriented programming language such as Java, Smalltalk, C++ or the like and conventional procedural programming languages, such as the ‘C’ programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

In some embodiments, clients, servers can communicate using any currently known or future developed network protocol such as HTTP (Hypertext Transfer Protocol) and can be interconnected with digital data communication (e.g., a communication network) in any form or medium. Examples of communication networks include a local area network (“LAN”), a wide area network (“WAN”), an internetwork (e. g., the Internet), and a peer-to-peer network (e. g., an ad hoc peer-to-peer network), as well as any currently known or future developed network.

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The modules involved in the embodiments of the present disclosure may be implemented by software or by hardware. A name of a module does not constitute a limitation to the unit itself in a certain case.

The functions described herein above may be performed, at least in part, by one or more hardware logic components. For example, exemplary types of hardware logic components that can be used include, without limitation, Field Programmable Gate Arrays (FPGAs), Application Specific Integrated Circuit (ASICs), Application Specific Standard Products (ASSPs), System on Chip (SOCs), Complex Programmable Logic Devices (CPLDs), etc.

In the context of this disclosure, a computer-readable medium may be tangible media that can contain, or store a program for use by or in connection with an instruction execution system, apparatus, or device. The computer readable medium may be a computer readable signal medium or a computer readable storage medium. The computer readable medium may include, but is not limited to, an electronic, magnetic, optical, electromagnetic, infrared, or semiconductor system, apparatus, or device, or any suitable combination of the foregoing. More specific examples of the computer readable storage medium may include an electrical connection based on one or more wires, a portable computer diskette, a hard disk, a random access memory (RAM), a read-only memory (ROM), an erasable programmable read-only memory (EPROM or Flash memory), an optical fiber, a compact disc read-only memory (CD-ROM), an optical storage device, a magnetic storage device, or any suitable combination of the foregoing.

According to a first aspect, according to one or more embodiments of the present disclosure, an interface switching method is provided, including:
in response to an interface switching instruction triggered by a user, extracting a target visual element from a first interface or a second interface, the interface switching instruction being used for instructing to switch the first interface to the second interface, the target visual element being a visual element shared by the first interface and the second interface;
adding the target visual element to a top layer of a view of a first position of the first interface, the first position being an original position of the target visual element in the first interface;
in response to switching the first interface to the second interface, moving the target visual element from the first position to a second position of the target visual element in the second interface.

According to one or more embodiments of the present disclosure, an animation playing parameter of a target visual element extracted from the first interface is different from an animation playing parameter of a target visual element extracted from the second interface.

According to one or more embodiments of the present disclosure, the animation playing parameter comprises a view state of the target visual element and an animation effect comprised by the target visual element;
wherein, the view state is used for indicating a playing progress of a playing content in the target visual element, the animation effect being a switching effect between playing contents in the target visual element.

According to one or more embodiments of the present disclosure, in response to the target visual element being a visual element extracted from the second interface, after the adding the target visual element to a top layer of a view of a first position of the first interface, the method further comprises:
synchronizing a first animation playing parameter of the target visual element in the first interface with a second animation playing parameter of the target visual element in the second interface.

According to one or more embodiments of the present disclosure, the synchronizing a first animation playing parameter of the target visual element in the first interface with a second animation playing parameter of the target visual element in the second interface comprises:
traversing and saving a view state and an animation effect of the target visual element in the first interface; and
sequentially adding the view state and the animation effect of the target visual element in the first interface to the second animation playing parameter.

According to one or more embodiments of the present disclosure, after the adding the target visual element to a top layer of a view of a first position of the first interface, the method further comprises:
keep the target visual element to perform animation playing based on a playing progress corresponding to the view state.

According to one or more embodiments of the present disclosure, the first position and the second position are relative positions of the target visual element on a display interface.

According to one or more embodiments of the present disclosure, before the moving the target visual element from the first position to a second position of the target visual element in the second interface, the method further comprises:
obtaining a relative position between the target visual element and a reference visual element in the second interface;
converting the relative position between the target visual element and the reference visual element in the second interface into the second position.

According to one or more embodiments of the present disclosure, the target visual element comprises an image carousel component, a video carousel component, or a text carousel component.

According to a second aspect, in one or more embodiments of the present disclosure, an interface switching apparatus is provided, including:
an extraction module, configured to in response to an interface switching instruction triggered by a user, extract a target visual element from a first interface or a second interface, the interface switching instruction being used for instructing to switch the first interface to the second interface, the target visual element being a visual element shared by the first interface and the second interface;
an adding module, configured to add the target visual element to a top layer of a view of a first position of the first interface, the first position being an original position of the target visual element in the first interface;
a switching module, configured to in response to switching the first interface to the second interface, move the target visual element from the first position to a second position of the target visual element in the second interface.

According to one or more embodiments of the present disclosure, an animation playing parameter of a target visual element extracted from the first interface is different from an animation playing parameter of a target visual element extracted from the second interface.

According to one or more embodiments of the present disclosure, the animation playing parameter comprises a view state of the target visual element and an animation effect comprised by the target visual element;
wherein, the view state is used for indicating a playing progress of a playing content in the target visual element, the animation effect being a switching effect between playing contents in the target visual element.

According to one or more embodiments of the present disclosure, the interface switching apparatus further comprises:
a synchronization module for synchronizing a first animation playing parameter of the target visual element in the first interface with a second animation playing parameter of the target visual element in the second interface.

According to one or more embodiments of the present disclosure, the synchronization module is specifically configured to traverse and save a view state and an animation effect of the target visual element in the first interface; and sequentially adding the view state and the animation effect of the target visual element in the first interface to the second animation playing parameter.

According to one or more embodiments of the present disclosure, the switching module is further configured to keep the target visual element to perform animation playing based on a playing progress corresponding to the view state.

According to one or more embodiments of the present disclosure, the first position and the second position are relative positions of the target visual element on a display interface.

According to one or more embodiments of the present disclosure, the switching module is further configured to obtain a relative position between the target visual element and a reference visual element in the second interface; convert the relative position between the target visual element and the reference visual element in the second interface into the second position.

According to one or more embodiments of the present disclosure, the target visual element comprises an image carousel component, a video carousel component, or a text carousel component.

According to a third aspect, an embodiment of the present disclosure provides an interaction method for terminal device, including:
displaying a first interface;
in response to a triggering operation of a user on the first interface, controlling the first interface to perform a first deformation, and triggering an interface switching instruction;
in response to detecting that the triggering operation ends, performing the interface switching method according to the first aspect;
displaying the target visual element in a second interface;
wherein, during a process of switching the first interface to a second interface, the target visual element after the first deformation performs a second deformation.

According to one or more embodiments of the present disclosure, the triggering operation comprises sliding at a preset angle on a screen of the terminal device.

According to a fourth aspect of the first interface, an embodiment of the present disclosure provides an electronic device, including:
a processor; and
a memory for storing a computer program;
wherein the processor is configured to implement, by executing the computer program, the interface switching method as described in the first aspect and various possible designs of the first aspect.

According to a fifth aspect, an embodiment of the present disclosure provides a computer readable storage medium. The computer readable storage medium stores a computer executable instruction. When a processor executes the computer executable instruction, the interface switching method in various possible designs of the first aspect and the first aspect is implemented.

According to a sixth aspect, an embodiment of the present disclosure provides a computer program product, including a computer program. When being executed by a processor, the computer program implements the interface switching method described in the foregoing first aspect and various possible designs of the first aspect.

According to a seventh aspect, an embodiment of the present disclosure provides a computer program. When being executed by a processor, the computer program implements the interface switching method in the foregoing first aspect and various possible designs of the first aspect.

The foregoing description is merely illustrative of the preferred embodiments of the present disclosure and of the technical principles applied thereto. As will be appreciated by those skilled in the art, the disclosure of the present disclosure is not limited to the technical solution formed by the specific combination of the described technical features. At the same time, it should also cover other technical solutions formed by any combination of the described technical features or equivalent features thereof without departing from the described disclosed concept. For example, the above features and technical features having similar functions disclosed in the present disclosure (but not limited thereto) are replaced with each other to form a technical solution.

In addition, while operations are depicted in a particular order, this should not be understood as requiring that the operations are performed in the particular order shown or in sequential order. Multitasking and parallel processing may be advantageous in certain circumstances. Likewise, while several specific implementation details are included in the above discussion, these should not be construed as limiting the scope of the present disclosure. Certain features that are described in the context of separate embodiments can also be implemented in combination in a single embodiment. Conversely, various features that are described in the context of a single embodiment can also be implemented in multiple embodiments separately or in any suitable sub-combination.

Although the subject matter has been described in language specific to structural features and/or methodological acts, it is to be understood that the subject matter defined in the appended claims is not necessarily limited to the specific features or acts described above. Rather, the specific features and acts described above are merely exemplary forms of implementing the claims.

1. An interface switching method, wherein the method comprises:
in response to an interface switching instruction, determining a target visual element from a first interface or a second interface, the interface switching instruction being used for instructing to switch the first interface to the second interface, the target visual element being a visual element shared by the first interface and the second interface;
adding the target visual element to a top layer of a view of a first position of the first interface, the first position being an original position of the target visual element in the first interface;
in response to switching the first interface to the second interface, moving the target visual element from the first position to a second position of the target visual element in the second interface.

2. The method of claim 1, wherein an animation playing parameter of a target visual element determined from the first interface is different from an animation playing parameter of a target visual element determined from the second interface.

3. The method of claim 2, wherein the animation playing parameter comprises a view state of the target visual element and an animation effect comprised by the target visual element;
wherein, the view state is used for indicating a playing progress of a playing content in the target visual element, the animation effect being a switching effect between playing contents in the target visual element.

4. The method of claim 1, wherein in response to the target visual element being a visual element determined from the second interface, after the adding the target visual element to a top layer of a view of a first position of the first interface, the method further comprises:
synchronizing a first animation playing parameter of the target visual element in the first interface with a second animation playing parameter of the target visual element in the second interface.

5. The method of claim 4, wherein the synchronizing a first animation playing parameter of the target visual element in the first interface with a second animation playing parameter of the target visual element in the second interface comprises:
traversing and saving a view state and an animation effect of the target visual element in the first interface; and
sequentially adding the view state and the animation effect of the target visual element in the first interface to the second animation playing parameter.

6. The method of claim 1, wherein after the adding the target visual element to a top layer of a view of a first position of the first interface, the method further comprises:
keep the target visual element to perform animation playing based on a playing progress corresponding to the view state.

7. The method of claim 1, wherein the first position and the second position are relative positions of the target visual element on a display interface.

8. The method of claim 1, wherein before the moving the target visual element from the first position to a second position of the target visual element in the second interface, the method further comprises:
obtaining a relative position between the target visual element and a reference visual element in the second interface;
converting the relative position between the target visual element and the reference visual element in the second interface into the second position.

9. The method of claim 1, wherein the target visual element comprises an image carousel component, a video carousel component, or a text carousel component.

10. (canceled)

11. An interaction method, comprising:
displaying a first interface;
in response to a triggering on the first interface, applying a first deformation to the first interface, and triggering an interface switching instruction;
in response to detecting that the triggering operation ends, performing the interface switching method as claimed in claim 1;
displaying a target visual element in a second interface;
wherein, during a process of switching the first interface to a second interface, the target visual element after the first deformation performs a second deformation.

12. The method of claim 11, wherein the triggering operation comprises sliding at a preset angle on a screen of the terminal device.

13. An electronic device, comprising:
a processor;
a memory for storing a computer program;
wherein upon executing the computer program the processor is configured to implement an interface switching method comprising:
in response to an interface switching instruction, determining a target visual element from a first interface or a second interface, the interface switching instruction being used for instructing to switch the first interface to the second interface, the target visual element being a visual element shared by the first interface and the second interface;
adding the target visual element to a top layer of a view of a first position of the first interface, the first position being an original position of the target visual element in the first interface;
in response to switching the first interface to the second interface, moving the target visual element from the first position to a second position of the target visual element in the second interface; or
to implement an interface switching method comprising:
displaying a first interface;
in response to a triggering on the first interface, applying a first deformation to the first interface, and triggering an interface switching instruction;
in response to detecting that the triggering operation ends, performing the interface switching method as claimed in claim 1;
displaying a target visual element in a second interface;
wherein, during a process of switching the first interface to a second interface, the target visual element after the first deformation performs a second deformation.

14.-16. (canceled)

17. The electronic device of claim 13, wherein an animation playing parameter of a target visual element determined from the first interface is different from an animation playing parameter of a target visual element determined from the second interface.

18. The electronic device of claim 17, wherein the animation playing parameter comprises a view state of the target visual element and an animation effect comprised by the target visual element;
wherein, the view state is used for indicating a playing progress of a playing content in the target visual element, the animation effect being a switching effect between playing contents in the target visual element.

19. The electronic device of claim 13, wherein in response to the target visual element being a visual element determined from the second interface, after the adding the target visual element to a top layer of a view of a first position of the first interface, the method further comprises:
synchronizing a first animation playing parameter of the target visual element in the first interface with a second animation playing parameter of the target visual element in the second interface.

20. The electronic device of claim 19, wherein the synchronizing a first animation playing parameter of the target visual element in the first interface with a second animation playing parameter of the target visual element in the second interface comprises:
traversing and saving a view state and an animation effect of the target visual element in the first interface; and
sequentially adding the view state and the animation effect of the target visual element in the first interface to the second animation playing parameter.

21. The electronic device of claim 13, wherein after the adding the target visual element to a top layer of a view of a first position of the first interface, the method further comprises:
keeping the target visual element to perform animation playing based on a playing progress corresponding to the view state.

22. The electronic device of claim 13, wherein the first position and the second position are relative positions of the target visual element on a display interface.

23. The electronic device of claim 13, wherein before the moving the target visual element from the first position to a second position of the target visual element in the second interface, the method further comprises:
obtaining a relative position between the target visual element and a reference visual element in the second interface;
converting the relative position between the target visual element and the reference visual element in the second interface into the second position.

24. The electronic device of claim 13, wherein the target visual element comprises an image carousel component, a video carousel component, or a text carousel component.
